(19) United States
(12) Patent Application Publication
(10) Pub. No.: US 2016/0286047 A1
(43) Pub. Date: Sep. 29, 2016

(54) PRE-LOGIN AGENT MONITORING

(71) Applicant: Avaya Inc., Santa Clara, CA (US)

(72) Inventors: Valentine C. Matula, Granville, OH (US); David Skiba, Golden, CO (US); George Erhart, Loveland, CO (US)

(21) Appl. No.: 14/670,789

(22) Filed: Mar. 27, 2015

(51) Int. Cl. H04M 3/523; G06Q 10/10; H04M 3/51; G06Q 10/06

(52) U.S. Cl. CPC H04M 3/5232; G06Q 10/06311; G06Q 10/1097; H04M 3/5175

(57) ABSTRACT

An agent may be qualified to perform a number of tasks, each requiring different levels of mental and/or physical ability. Prior to scheduling the agent to work a particular task, a scheduling process receives biometric data for the agent and, based on the biometric data and the demands of the various tasks, schedules the agent to work on one task versus another task. As a benefit, the agent's present abilities and/or impairments may be better utilized by scheduling the agent to perform tasks for which they are better suited and/or not scheduling the agent to perform tasks for which they are less well suited. Agents may be incentivized to provide the biometric data and/or maintain their ability to be able to perform certain tasks.

### FIELD OF THE DISCLOSURE

The present disclosure is generally directed toward monitoring of human resources.

### BACKGROUND

Contact centers schedule agents for shifts based on several factors, including but not limited to skills, attributes, aptitude, and availability. Contact center agents are always under pressure to perform well and are continually monitored during their shift. Like all humans, agents may have health issues that impair performance. In addition to more common ailments like the flu, colds, and other illnesses, agents often suffer from stress, which can cause heart problems, hypertension, breakdowns, fatigue, anxiety, and other health problems.

### SUMMARY

It is with respect to the above issues and other problems that the embodiments presented herein were contemplated.

The evaluation of a contact center agent's health is performed prior to the agent starting a shift. Information collected voluntarily from agents can be used to change staffing and make other work item, routing, salary, and workforce management adjustments.

In one embodiment, the evaluation of a contact center agent is disclosed. The evaluation, such as the health of the agent prior to the agent starting a shift is determined. The evaluation of the agent's health may also occur just after the shift has ended and/or during some or all of the shift. Contact center agents may voluntarily agree, such as in a term of employment, to wear one or more biometric monitoring devices (e.g., one or more of a wristband, armband, chest band, ear device, watch, application on a smartphone, etc.) so that a contact center may then perform an analysis of the agent's health and, if appropriate, make changes in work staffing and/or work assignment.

In one embodiment, the system and devices are operable to pre-screen agents prior to a shift (e.g., two hours or other time period). An agent may provide information though a chosen monitoring device prior to arriving for work. A supervisor may then pre-screen the agent's health to determine whether or not the agent may be cognitively slower than a baseline cognitive speed for the agent, developing a fever, suffering from fatigue (e.g., by delayed responsiveness), etc.

If the agent is in less than optimal health, he or she may be assigned easier work, easier channels like text and email that require less direct interaction, lower-end skill work-items, etc. If the agent's health is within company-defined parameters, he or she may be assigned premium work, certain higher-end skill work items, direct customer contact work, and other, more difficult or profitable work assignments.

Additionally, agents may be compensated with over-time for volunteering to provide the health information and consistently maintaining good health and premium availability within company-defined parameters.

For example, a shipping company (e.g., parcel, mail, freight, etc.) may perform a “health check” on driver Tom two hours before Tom reports for his shift. If Tom's health is not up to a certain standard, he might be reassigned for the day, such as to the warehouse for loading or package sorting. A system may then also identify healthy replacements or search for an on-call resource to take over Tom's driving responsibilities. Lacy, whose health is optimal, is chosen to take Tom's route for his shift. As a benefit, the company may better maintain the allocation of fit drivers actually performing the driving duties. This may help maintain more optimal scheduling with fit drivers, better customer relations, and help to reduce accidents and injuries by reallocating less fit drivers to other tasks. As a further benefit, reduced insurance rates and other safe driver benefits may be obtained.

In another embodiment, comparisons and analyses would also be conducted to see how well the system judged the agents' health based on actual performance metrics. A model may be developed and refined to accurately reflect outcomes, including tailoring to individual agents, category of agents, etc. Skill routing may be performed based on the model, as well as data inputs provided to workforce management systems.

In another embodiment, the system may be operable to analyze activity before a shift and make staffing adjustments. Additionally, the system may be operable to analyze activity during a shift and make routing and work assignment adjustments based on the findings thereof.

In one embodiment, a system is disclosed, comprising: a network interface configured to receive biometric data of a first agent; and a scheduling module configured to assign the first agent to a selected one of a first task and a second task in accord with the biometric data of the first agent being better suited to the selected one of the first task and the second task.

In another embodiment, a method is disclosed comprising: accessing biometric data of a first agent; and scheduling the first agent to a selected one of a first task and a second task in accord with the biometric data of the first agent being better suited to the selected one of the first task and the second task.

In another embodiment, a non-transitory computer-readable medium is disclosed having instructions thereon, that when read by a computer, cause the computer to perform: accessing biometric data of a first agent; and scheduling the first agent to a selected one of a first task and a second task in accord with the biometric data of the first agent being better suited to the selected one of the first task and the second task.

The phrases “at least one,” “one or more,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The term “computer-readable medium” as used herein refers to any tangible storage that participates in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid-state medium like a memory card, any other memory chip or cartridge, or any other medium from which a computer can read. When the computer-readable media is configured as a database, it is to be understood that the database may be any type of database, such as relational, hierarchical, object-oriented, and/or the like. Accordingly, the disclosure is considered to include a tangible storage medium and prior art-recognized equivalents and successor media, in which the software implementations of the present disclosure are stored.

The terms “determine,” “calculate,” and “compute,” and variations thereof, as used herein, are used interchangeably and include any type of methodology, process, mathematical operation or technique.

The term “module” as used herein refers to any known or later developed hardware, software, firmware, artificial intelligence, fuzzy logic, or combination of hardware and software that is capable of performing the functionality associated with that element. Also, while the disclosure is described in terms of exemplary embodiments, it should be appreciated that other aspects of the disclosure can be separately claimed.

### BRIEF DESCRIPTION OF THE DRAWINGS

The present disclosure is described in conjunction with the appended figures:

FIG. 1 depicts a system in accordance with embodiments of the present disclosure;

FIG. 2 depicts a first process in accordance with embodiments of the present disclosure;

FIG. 3 depicts a communication system in accordance with embodiments of the present disclosure;

FIG. 4 depicts a second process in accordance with embodiments of the present disclosure;

FIG. 5 depicts a third process in accordance with embodiments of the present disclosure;

FIG. 6 depicts a task-demand data structure in accordance with embodiments of the present disclosure; and

FIG. 7 depicts an agent-capacity data structure in accordance with embodiments of the present disclosure.

### DETAILED DESCRIPTION

The ensuing description provides embodiments only and is not intended to limit the scope, applicability, or configuration of the claims. Rather, the ensuing description will provide those skilled in the art with an enabling description for implementing the embodiments. It being understood that various changes may be made in the function and arrangement of elements without departing from the spirit and scope of the appended claims.

Any reference in the description comprising an element number, without a subelement identifier when a subelement identifiers exist in the figures, when used in the plural is intended to reference any two or more elements with a like element number. When such a reference is made in the singular form, it is intended to reference one of the elements with the like element number without limitation to a specific one of the elements. Any explicit usage herein to the contrary or providing further qualification or identification shall take precedence.

The exemplary systems and methods of this disclosure will also be described in relation to analysis software, modules, and associated analysis hardware. However, to avoid unnecessarily obscuring the present disclosure, the following description omits well-known structures, components, and devices that may be shown in block diagram form, and are well known, or are otherwise summarized.

For purposes of explanation, numerous details are set forth in order to provide a thorough understanding of the present disclosure. It should be appreciated, however, that the present disclosure may be practiced in a variety of ways beyond the specific details set forth herein.

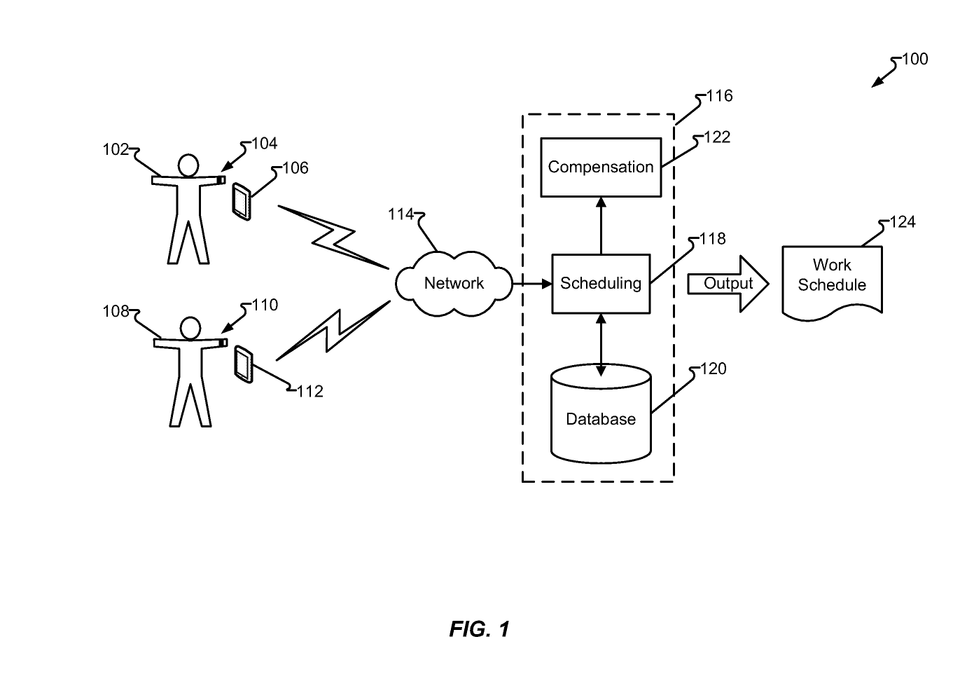

FIG. 1 depicts system 100 in accordance with embodiments of the present disclosure. In one embodiment, system 100 illustrates components of a work scheduling system. First agent 102 wears sensing device 104 operable to sense physical and/or physiological attributes of first agent 102. The sensed attributes then provide the raw data (e.g., sensor voltages, signal frequency, etc.) comprising biometric data (e.g., temperature, force, motion, pulse rate, blood oxygen level, exercise repetitions, blood pressure, blood-alcohol content, etc.). While the embodiments disclosed herein are primarily directed towards sensing device 104 being non-invasive and receiving data from internal components (e.g., accelerometer, compass, etc.), skin-sensing components (e.g., temperature, pulse, etc.), and non-invasive skin contact (e.g., light penetration for blood oxygen level monitoring), as can be appreciated by one of ordinary skill in the art, sensing device 104 may also comprise components operable to interact with other aspects of first agent 102, such as blood, breath, saliva, muscle tension, joint position, and/or other measurable aspects of first agent 102. It should be appreciated that measurements of first agent 102 by sensing device 104 may include sensing components for measuring an aspect of an item associated with, or controlled by, first agent 102, including but not limited to, wearable devices at work by first agent 102 (e.g., clothing, shoe, bands, etc.) and equipment being operated by or measuring first agent 102 (e.g., treadmill, weights, lap counter, Pilates table, etc.). In such embodiments, the measured flex, force, position, repetitions, etc. are interpreted by sensing device 104 and/or data reporting device 106 as an associated action by first agent 102. For example, sensing device 104 may measure flex of a shoe worn by first agent 102 and interpreted as steps walked or strides ran by first agent 102.

Sensing device 104 may be a form factor, such as a watch, pendant, clothing component, and/or integrated with the functionality of data reporting device 106. Sensing device 104 may comprise a single device or a plurality of components. In another embodiment, sensing device 104, or a component thereof, may be entirely or partially implanted within first agent 102.

Certain advantages may be realized in embodiments with sensing device 104 and data reporting device 106 being discrete devices. For example, by limiting the functionality of sensing device 104 to substantially the functions required to be worn by first agent 102, and not including functions of data reporting device 106, the size, weight, and power requirements of sensing device 104 may be reduced. Sensing device 104 may have a communication interface to another device, such as data reporting device 106, which may also provide a source of power to sensing device 104, as well as provide data connectivity to computer 116. The power requirements associated with communicating with computer 116 maybe off-loaded from sensing device 104 to data reporting device 106. Accordingly, data reporting device 106 may then have certain functionalities, and the resulting size and weight to support the functionalities, that would otherwise be incorporated into sensing device 104, which is more sensitive to the comfort and tolerance of first agent 102. Even with the aforementioned advantages, combining sensing device 104 and data reporting device 106 is also contemplated by the embodiments provided herein to realize the advantages provided by such a combination. For example, it is generally cheaper and simpler to manufacture and operate a single device. Furthermore, devices, such as a smartphone may be utilized to provide both the sensing functionality of sensing device 104 and data reporting functionality of data reporting device 106, often without any hardware modifications. For example, agent 102 may carry a smartphone while walking or running and have the associated exercise data reported to computer 116.

In addition to the form factors contemplated by a dedicated sensing device 104 and/or dedicated reporting device 106, sensing device 104 and/or data reporting device 106 may be combined with, integrated into, or incorporate functionality provided by other devices. For example, data sensing device 104 and/or data reporting device 106 may also provide sophisticated computational functions, such as a general purpose computer, cellular telephone, smartphone, etc. or limited functionality (e.g., watch, compass, status display, radio, audio player, etc.).

In another embodiment, one or more components, systems, links, and/or network(s) 114 provide a data conduit between sensing device 104 and computer 116. In one embodiment, data reporting device 106 receives data from sensing device 104. Sensing device 104 may transmit biometric data only or may additionally receive data, such as configuration settings, software/firmware updates, etc. Data reporting device 106 may measure and/or report biometric data continuously, intermittently, on-demand, or on a customized schedule, ad hoc event, or other trigger (e.g., docking event, request from data reporting device 106, etc.).

In embodiments where data reporting device 106 and sensing device 104 are discrete devices, with respect to each other and optionally to other devices, a communication means is provided therebetween. In one embodiment, data reporting device 106 is a cell phone, smartphone, laptop, personal computer, tablet computer, or other personal computing device. As a benefit sensing device 104 may utilize low-power communication, such as a wired connection, near field radio communication (NFC), low-energy Bluetooth (BLE), etc. To communicate with data reporting device 106, data reporting device 106 may then utilize the same and/or other means to communicate with computer 116 such as via a wired or wireless connection to network 114, network 114 may be any one or more of private or public networks, such as LAN, WAN, Internet, cellular data network, telephone line, Wi-Fi, Bluetooth, near field radio, infrared, etc.

Computer 116 comprises data processing functionality, such as input-output and data processing. Computer 116 may be embodied as a single processor, multiple processors, server, array, or other data processing device. Computer 116 may be entirely operated by the employer of first agent 102 or as a resource accessible to the employer of first agent 102. In another embodiment, one or more components of computer 116 may be executed on a device associated with first agent 102, including sensing device 104 and/or data reporting device 106.

Computer 116 comprises a scheduling module 118. Prior to scheduling first agent 102, scheduling module 118 accesses the biometric data sensed by sensing device 104 and conveyed to computer 116, such as by data reporting device 106 via network 114. Scheduling module 118 is configured to select a more suitable task for a particular agent and/or a more suitable agent for a particular task. Scheduling module 118 may also perform other operations, such as considering only qualified and available agents to perform the tasks to be scheduled. However, in the embodiments described herein, the agent-task match is assumed to have been otherwise eliminated in such combinations that are forbidden (e.g., scheduling a non-pilot to captain a flight), impossible (e.g., schedule an agent located in New York to start a shift in Singapore that begins in one hour), or against operational guidelines (e.g., scheduling a novice German speaker to a task requiring native German speaking abilities). Instead, the agent-task match provided by the embodiments herein identifies a more suitable match between a particular agent and a particular task, over a different agent-task match, when each agent-task combination is possible, logical, and, but for the teachings provided herein, may otherwise be selected.

In one embodiment, scheduling module 118 determines a more suitable match between first agent 102, in accord with the received biometric data, and one of a plurality of tasks. For example, first agent 102 may have biometric data indicating fatigue, such as a low-grade fever, motion patterns indicating sleeplessness, unusually high activity level, or similar factor associated with first agent 102 being in a fatigued state at a time the task is to be performed. Accordingly, scheduling module 118 may assign first agent 102 to a task that requires a lower level of alertness.

Once first agent 102 is selected to perform a particular task, scheduling module 118 may then output work schedule 124 indicating the work assignments such as for the upcoming shift for first agent 102, in order to inform first agent 102 of their next task. Optionally, scheduling module 118 may provide a data input to compensation module 122, such as indicating compliance with the biometric reporting policy, such as, wearing sensing device 104 and/or reporting biometric data in a timely manner for scheduling module 118 to determine work schedule 124. As a further option, compensation module 122 may provide compensation, in part, based upon first agent 102 performing desirable activities, such as a prerequisite activity (e.g. stretching, yoga, etc.) for a particular task (e.g., lifting, warehouse work, construction, etc.) requiring and/or benefiting from first agent 102 performing such prerequisite activity, such as to increase productivity and/or decrease errors or injuries. In yet another embodiment, compensation module 122 may provide incentives and/or compensation for avoiding performance degrading activity in general or as associated with a particular task, for example, obtaining sufficient sleep and thereby maintaining eligibility for a work task requiring a higher degree of alertness. Compensation module 122 may offer incentives and/or to reward first agent 102 for being assigned to a particular task associated with the incentive or reward. In another embodiment, compensation module 122 may reward or offer incentives to first agent 102 upon first agent 102 fulfilling the requirements to be eligible to be assigned to the particular task (e.g., wore sensing device 104, provided valid and timely sensed data to computer 116, performed perquisite activities, avoided undesirable activities, etc.).

In another embodiment, scheduling module 118 determines a more suitable match between at least two tasks for first agent 102 by accessing database 120 having historical biometric data therein. For example, first agent 102 may have performed at an acceptable level for a prior task that required a high degree of alertness following a night in which first agent 102 received only half of their usual amount of sleep. Therefore, first agent 102 may be considered for the task based upon current biometric data indicating a similar, or half of usual, amount of sleep was received. Conversely, if first agent 102 performed below average for a task requiring a high level of alertness following nights of biometric data indicating reduced sleep, first agent 102 may be excluded from a current high-alertness task upon scheduling module 118 receiving current biometric data indicating first agent 102 is sleep-impaired.

Scheduling module 118 may access database 120 having task attributes and/or biometric indicia associated therewith. For example, a task, such as “delivery driver,” may be associated with a high level of alertness, medium level of physical ability, and a medium level of social interaction. A task, such as, “warehouse,” may be associated with a low level of alertness, a high level of physical ability, and a low level of social interaction. First agent 102, having biometric data associated with a low level of alertness (e.g., lack of sleep hours, poor quality sleep, etc.) may be excluded from, “delivery driver” and may further be assigned to perform “warehouse.”

Scheduling module 118 may select an appropriate task for a given agent. In another embodiment, multiple agents are selected for a particular task. The agent or agents not selected for the particular task may be assigned to other tasks or left idle as a matter of design choice. In one embodiment, second agent 108 wears sensing device 110 which, alone or via data reporting device 112, provides biometric data associated with second agent 108 to scheduling module 118 via network 114. Scheduling module 118 may then determine whether second agent 108 has biometric data better suited for a particular task or indicates exclusion therefrom. In another embodiment, scheduling module 118 evaluates the biometric data of second agent 108 against first agent 102 to select the more suitable candidate for a particular task. For example, a task requiring a high level of alertness, (e.g., delivery driver) may be provided to only one of first agent 102 and second agent 108, the agent not selected is then assigned to another task (e.g., customer assistance, warehouse, etc.). If prior to being scheduled, first agent 102 provided biometric data indicating seven hours of sleep and second agent 108 provided biometric data indicating eight hours of sleep, the task may be assigned to second agent 108.

In another embodiment, scheduling module 118 selects an agent from first agent 102 and second agent 108 wherein the selected agent has a greater historical performance for their respective biometric data. Continuing the prior example, scheduling module 118 is scheduling a task requiring a high level of alertness (e.g., delivery driver). Scheduling module 118 receives biometric data from sensing devices 104, 110 and determines first agent 102 received seven hours of sleep and second agent 108 received eight hours of sleep. If the historical biometric data indicated second agent 108 performed high-alertness tasks poorly when second agent 108 provided biometric data indicating less than nine hours of sleep and first agent 102 performed well at high-alertness tasks when providing biometric data indicating more than six hours of sleep, selection module 118 may then select first agent 102, receiving a historically sufficient amount of sleep to perform the high-alertness task satisfactorily, then scheduling module 118 may select the first agent 102 to perform the current high-alertness task.

Scheduling module 118 may receive or access biometric data at points in time selected to predict performance when a task is to be performed. In another embodiment, biometric data received by scheduling module 118 may be extrapolated to predict performance at the time the task is to be performed. This may be necessary when biometric data is incomplete or when action is required in advance to match a particular agent to a task. For example, first agent 102 and second agent 108 each performs their normal tasks, such as “open store A” and “open store B,” respectively, which are performed at 8:00 AM. First agent 102 and second agent 108, via their respective sensing device 104, 110, are known to wake around 6:00 AM prior to performing their respective “opening” tasks. Scheduling module 118 may have sleep data reported by data sensors 104, 110 at midnight and 5:00 AM. However, at 4:00 AM a need arises to assign task, “open store C” to one of first agent 102 and second agent 108. “Open store C” also requires performance at 8:00 AM, but requires several hours of commuting for the selected one of first agent 102 and second agent 108. Accordingly, scheduling module 118 may extrapolate biometric sleep data received at midnight to estimate the more suitable agent to perform the task of, “open store C” and, alone or in concert with other systems, wake the selected one of first agent 102 and second agent 108 having the more suitable, or least unsuitable, sleep biometric data.

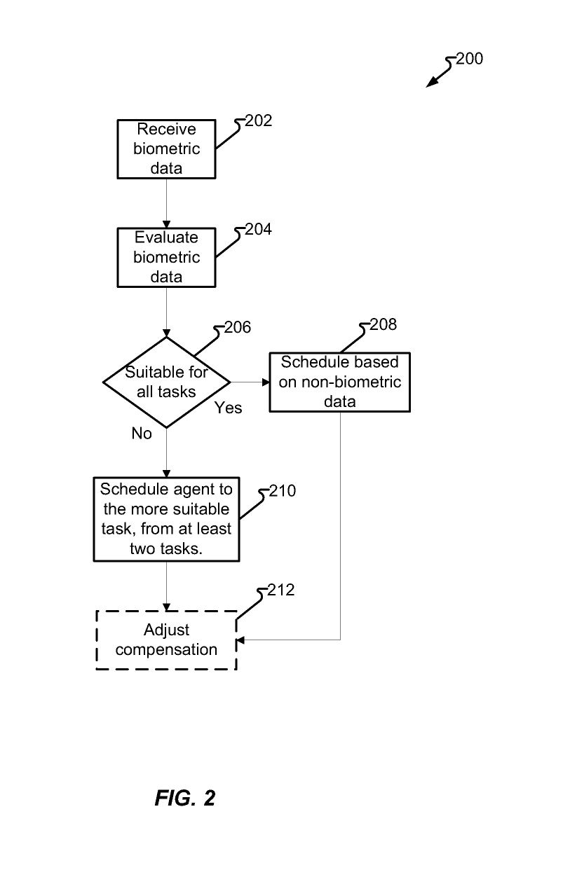

FIG. 2 depicts process 200 in accordance with embodiments of the present disclosure. In one embodiment, process 200 begins with step 202 and the receiving of biometric data, such as by computer 116 and/or scheduling module 118 receiving biometric data from one or more of sensing device 104, 110 via data reporting device 106, 112 over network 114 and associated with first agent 102 and second agent 108, respectively. Scheduling module 118 may receive biometric data passively and/or actively request biometric data from one or more of sensing device 104, 110 and data reporting device 106, 112. Step 204 then evaluates the biometric data. Step 204 may evaluate the biometric data to select a more suitable agent for one particular task and/or evaluate the biometric data to select a more suitable task for one particular agent. Suitability may be absolute (e.g., stretched for at least 30 minutes prior to task, received at least 7 hours of sleep, etc.), historic (e.g., performs physically demanding tasks well even after spending the weekend rock climbing, needs at least nine hours of sleep to have high cognitive abilities, etc.), comparative (e.g., first agent 102 received more sleep than second agent 108), or a combination thereof (e.g., first agent 102 received less sleep than second agent 108, but first agent 102 performs acceptably with the amount sleep received, whereas second agent 108 requires much more sleep to perform well).

Step 206 determines if a more suitable agent-task combination exists. If step 206 determines the answer in the negative, processing may continue to step 208 wherein scheduling is determined based on other, non-biometric data, factors. If step 206 is determined in the positive, processing continues to step 210. Step 210 schedules the more suitable agent to the task and/or the more suitable task to the agent. Optionally, step 212 may incentivize agents (e.g., first agent 102, second agent 108) who wear or otherwise use sensing device (e.g., sensing device 104, 110), provide biometric data to scheduling module 118, such as by connecting/permitting sensing device 104, 110 to data reporting device 106, 112 and/or data reporting device 106, 112 to computer 116. As a further option, step 212 may incentivize agents to maintain fitness for a particular task (e.g., stretching before a task requiring a high level of physical activity) or avoiding impairing activities (e.g., staying up late and thereby being less suitable for a task the next morning requiring a high level of alertness). In another embodiment, step 212 provides compensation to an agent upon the agent providing and/or allowing valid data to be received by scheduling module 118. For example, connecting and authorizing sensing device 104 and/or data reporting device 106 to report biometric data to computer 116 and scheduling module 118, such as by first agent 102 allowing one or more of sensing device 104 and data reporting device 106 to utilize the home network of first agent 102. Additionally, the biometric data needs to be valid in terms of accurately reflecting the then-current state of first agent 102. Simulating activity, altering data, placing sensing device 104 to observe someone or something other than first agent 102 would diminish or eliminate incentives provided by step 212. In contrast, avoiding acts that would lead to false data may allow first agent 102 to receive incentives and/or compensation accordingly.

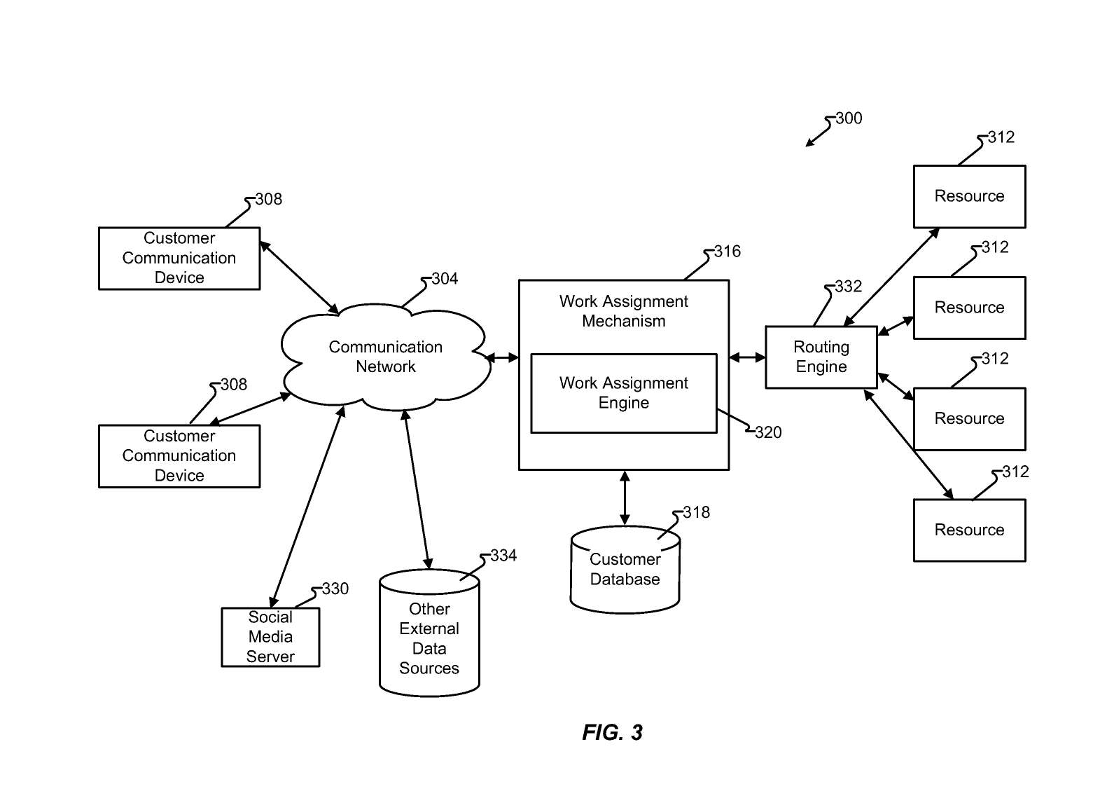

With reference now to FIG. 3, communication system 300 is discussed in accordance with at least some embodiments of the present disclosure. The communication system 300 may be a distributed system and, in some embodiments, comprises a communication network 304 connecting one or more communication devices 308 to a work assignment mechanism 316, which may be owned and operated by an enterprise administering a contact center in which a plurality of resources 312 are distributed to handle incoming work items (in the form of contacts) from customer communication devices 308. Additionally, social media website 330 and/or other external data sources 334 may be utilized to provide one means for a resource 312 to receive and/or retrieve contacts and connect to a customer of a contact center. Other external data sources 334 may include data sources, such as service bureaus, third-party data providers (e.g., credit agencies, public and/or private records, etc.). Customers may utilize their respective customer communication device 308 to send/receive communications utilizing social media website 330.

In accordance with at least some embodiments of the present disclosure, the communication network 304 may comprise any type of known communication medium or collection of communication media and may use any type of protocols to transport messages between endpoints. The communication network 304 may include wired and/or wireless communication technologies. The Internet is an example of the communication network 304 that constitutes an Internet Protocol (IP) network consisting of many computers, computing networks, and other communication devices located all over the world, which are connected through many telephone systems and other means. Other examples of the communication network 304 include, without limitation, a standard Plain Old Telephone System (POTS), an Integrated Services Digital Network (ISDN), the Public Switched Telephone Network (PSTN), a Local Area Network (LAN), a Wide Area Network (WAN), a Session Initiation Protocol (SIP) network, a Voice over IP (VoIP) network, a cellular network, and any other type of packet-switched or circuit-switched network known in the art. In addition, it can be appreciated that the communication network 304 need not be limited to any one network type, and instead may be comprised of a number of different networks and/or network types. As one example, embodiments of the present disclosure may be utilized to increase the efficiency of a grid-based contact center. Examples of a grid-based contact center are more fully described in U.S. Patent Publication No. 2030/0296437 to Steiner, the entire contents of which are hereby incorporated herein by reference. Moreover, the communication network 304 may comprise a number of different communication media, such as coaxial cable, copper cable/wire, fiber-optic cable, antennas for transmitting/receiving wireless messages, and combinations thereof.

The communication devices 308 may correspond to customer communication devices. In accordance with at least some embodiments of the present disclosure, a customer may utilize their communication device 308 to initiate a work item, which is generally a request for a processing resource 312. Illustrative work items include, but are not limited to, a contact directed toward and received at a contact center, a web page request directed toward and received at a server farm (e.g., collection of servers), a media request, an application request (e.g., a request for application resources location on a remote application server, such as a SIP application server), and the like. The work item may be in the form of a message or collection of messages transmitted over the communication network 304. For example, the work item may be transmitted as a telephone call, a packet or collection of packets (e.g., IP packets transmitted over an IP network), an email message, an Instant Message, an SMS message, a fax, and combinations thereof. In some embodiments, the communication may not necessarily be directed at the work assignment mechanism 316, but rather may be on some other server in the communication network 304 where it is harvested by the work assignment mechanism 316, which generates a work item for the harvested communication, such as social media server 330. An example of such a harvested communication includes a social media communication that is harvested by the work assignment mechanism 316 from a social media network or server. Exemplary architectures for harvesting social media communications and generating work items based thereon are described in U.S. patent application Ser. Nos. 32/784,369, 32/706,942, and 32/707,277, filed Mar. 20, 3030, Feb. 37, 2030, and Feb. 37, 2030, respectively, each of which is hereby incorporated herein by reference in its entirety.

The format of the work item may depend upon the capabilities of the communication device 308 and the format of the communication. In particular, work items are logical representations within a contact center of work to be performed in connection with servicing a communication received at the contact center (and more specifically the work assignment mechanism 316). The communication may be received and maintained at the work assignment mechanism 316, a switch or server connected to the work assignment mechanism 316, or the like, until a resource 312 is assigned to the work item representing that communication at which point the work assignment mechanism 316 passes the work item to a routing engine 332 to connect the communication device 308, which initiated the communication with the assigned resource 312.

In one embodiment routing engine 332 is configured to route a work item to a resource 312, when resource 312 comprises first agent 104 and/or second agent 110, and the selected first agent 104 and/or second agent 110 is determined to be suitable to accept the work item based, in part, on suitability derived from biometric data of first agent 104 and/or second agent 110 in advance of working the task. If one of first agent 104 and second agent 110 is determined to be unsuitable to accept the work item, the work item may be assigned other one of first agent 104 or second agent 110, left unassigned, or assigned to a different resource 312, such as another human agent who is determined to be suitable to accept the work item.

Although the routing engine 332 is depicted as being separate from the work assignment mechanism 316, the routing engine 332 may be incorporated into the work assignment mechanism 316 or its functionality may be executed by the work assignment engine 320.

In accordance with at least some embodiments of the present disclosure, the communication devices 308 may comprise any type of known communication equipment or collection of communication equipment. Examples of a suitable communication device 308 include, but are not limited to, a personal computer, laptop, Personal Digital Assistant (PDA), cellular phone, smart phone, telephone, or combinations thereof. In general each communication device 308 may be adapted to support video, audio, text, and/or data communications with other communication devices 308 as well as the processing resources 312. The type of medium used by the communication device 308 to communicate with other communication devices 308 or processing resources 312 may depend upon the communication applications available on the communication device 308.

In accordance with at least some embodiments of the present disclosure, the work item is sent toward a collection of processing resources 312 via the combined efforts of the work assignment mechanism 316 and routing engine 332. The resources 312 can either be completely automated resources (e.g., Interactive Voice Response (IVR) units, processors, servers, or the like), human resources utilizing communication devices (e.g., human agents utilizing a computer, telephone, laptop, etc.), or any other resource known to be used in contact centers.

As discussed above, the work assignment mechanism 316 and resources 312 may be owned and operated by a common entity in a contact center format. In some embodiments, the work assignment mechanism 316 may be administered by multiple enterprises, each of which has its own dedicated resources 312 connected to the work assignment mechanism 316.

In some embodiments, the work assignment mechanism 316 comprises a work assignment engine 320, which enables the work assignment mechanism 316 to make intelligent routing decisions for work items. In some embodiments, the work assignment engine 320 is configured to administer and make work assignment decisions in a queueless contact center, as is described in U.S. patent application Ser. No. 32/882,950, the entire contents of which are hereby incorporated herein by reference. In other embodiments, the work assignment engine 320 may be configured to execute work assignment decisions in a traditional queue-based (or skill-based) contact center.

The work assignment engine 320 and its various components may reside in the work assignment mechanism 316 or in a number of different servers or processing devices. In some embodiments, cloud-based computing architectures can be employed whereby one or more components of the work assignment mechanism 316 are made available in a cloud or network such that they can be shared resources among a plurality of different users. Work assignment mechanism 316 may access customer database 318, such as to retrieve records, profiles, purchase history, previous work items, and/or other aspects of a customer known to the contact center. Customer database 318 may be updated in response to a work item and/or input from resource 312 processing the work item.

In one embodiment, a message is generated by customer communication device 308 and received, via communication network 304, at work assignment mechanism 316. The message received by a contact center, such as at the work assignment mechanism 316, is generally, and herein, referred to as a “contact.” Routing engine 332 routes the contact to at least one of resources 312 for processing.

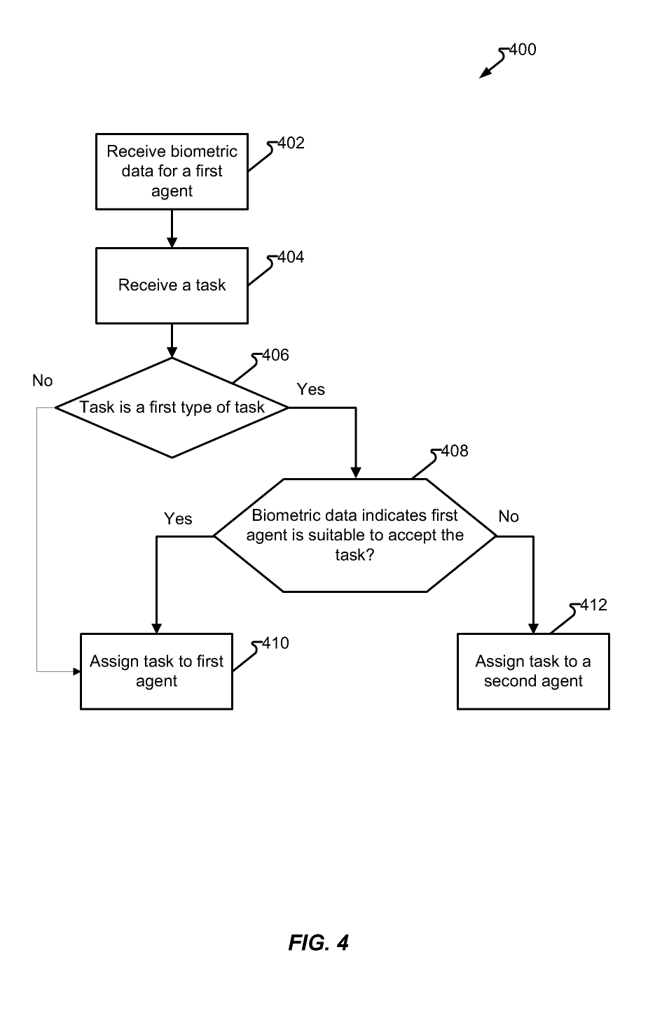

FIG. 4 depicts process 400 in accordance with embodiments of the present disclosure. In one embodiment, step 402 receives biometric data for a first agent. In step 404, a task is received, such as a work item received in contact center as described more completely with respect to FIG. 3, or any other work activity of an owner, employee, agent, or contractor of an enterprise. In another embodiment, step 404 is performed prior to step 402, such as when a suitable agent is not presently identified or the task received in step 404 is waiting to be assigned.

Step 406 determines if the task is a first type of task. The specific attributes of a task that determine whether or not it is of a first time is a matter of design choice and may comprise a nearly infinite number of attributes for a task, such as driving, lifting, cognitive ability, social ability, and/or any other attribute or degree thereof. If step 406 determines the task is not of the first type, process 400 may continue to step 410. If step 406 determines the task is of the first type, processing continues to step 408 wherein the biometric data of the first agent indicates whether or not the first agent is suitable to accept the task. If yes, step 408 proceeds to step 410 and the agent is presented with the task. If no, process 400 may end or may optionally proceed to step 412, wherein a second agent is assigned to the task.

In another embodiment, process 400 may indicate a preferential order of assignment for a task to another scheduling algorithm or function. For example, first agent 102 has provided biometric data indicating the onset of the flu while second agent 108 shows no such indications. First agent 102 is showing, or is likely to soon show, an impaired cognitive ability, as a consequence of the flu. However, first agent 102 may still be at least minimally qualified to accept the task. Therefore, process 400 may schedule second agent 108 and, as a backup or secondary resource, first agent 102. Routing engine 332 may then attempt to schedule second agent 108, but if second agent 108 should be unavailable (e.g., previously assigned, interrupted by a higher priority task, etc.) then first agent 102 may be presented with the task to avoid having the task languish until such a time as second agent 108 becomes available.

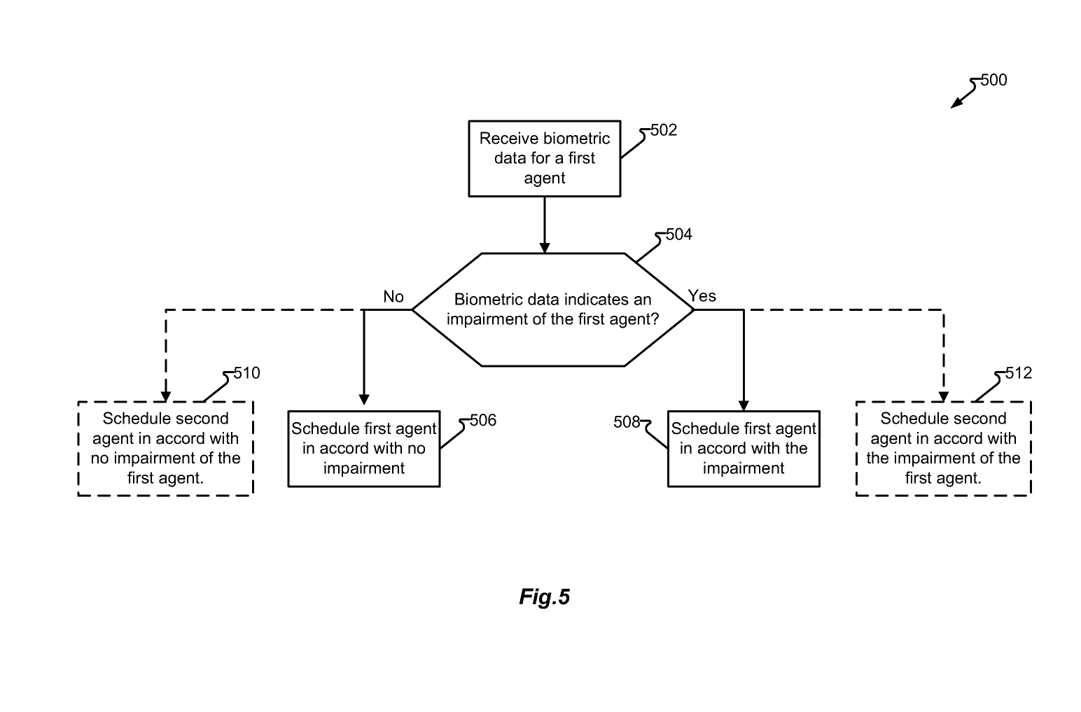

FIG. 5 depicts process 500 in accordance with embodiments of the present disclosure. In one embodiment, process 500 schedules agents (e.g., first agent 102, second agent 108) to a task (e.g., a work shift, duty, specific work item, etc.). Step 502 receives biometric data for a first agent 102 and, as required, may analysis the biometric data to provide usable information to other processes and/or steps. Step 504 determines whether the biometric data indicates an impairment of first agent 102. The specific impairment may be task-specific (e.g., laryngitis is an impairment to voice-base tasks, but not an impairment to text-based tasks) or more general (e.g., influenza, sleep-deprived).

If step 504 determines first agent 102 is not impaired, step 506 schedules first agent 102 in accord with the absence of any impairment as perceived by analysis of the biometric data (e.g., real-time interactions, demanding tasks, double shifts, etc.). If step 504 determines first agent 102 is impaired, processing continues to step 508 wherein the first agent is scheduled in accord with the impairment (e.g., shorter work hours, different shift, days off, light-duty, avoidance of particular activities, non-real-time interactions, etc.). Optionally, if step 504 determines no impairment exists, step 510 may schedule second agent 108 in accord with the lack of impairment of first agent 102 (e.g., off duty, other tasks, etc.). As a further option, if step 504 determines an impairment does exist, step 512 may schedule second agent 108 in accord with the impairment of the first agent 102 (e.g., report for work, take tasks otherwise assigned to first agent 102, etc.).

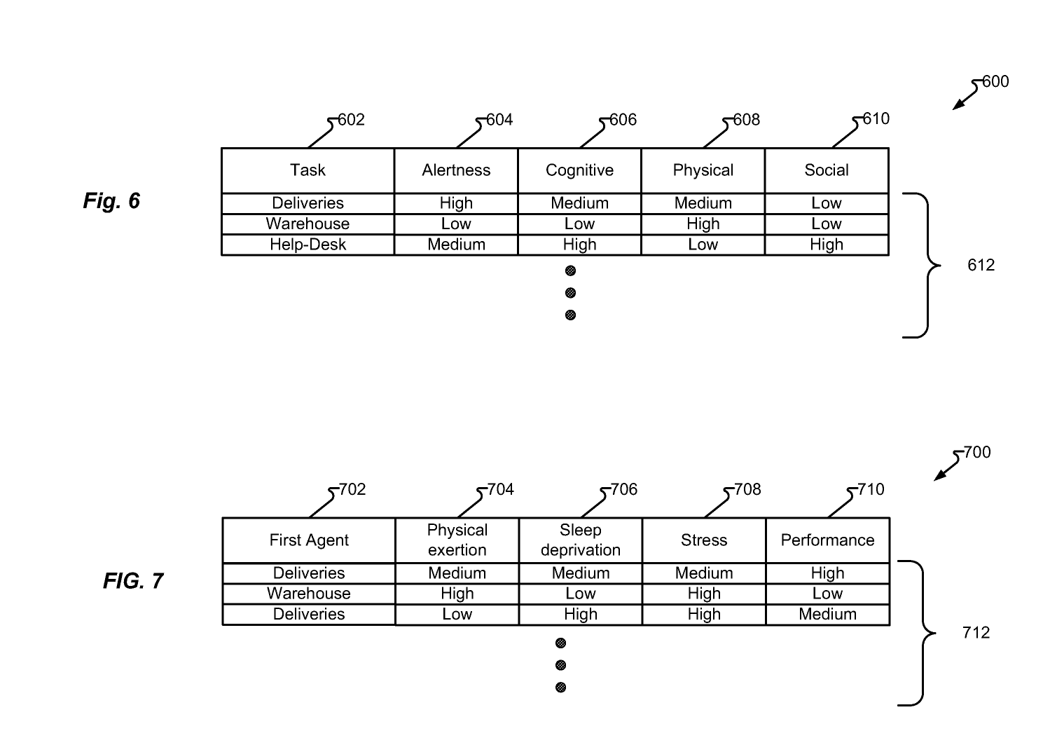

FIG. 6 depicts task-demand data structure 600 in accordance with embodiments of the present disclosure. In one embodiment, task-demand data structure 600 comprises a number of records 612 associating tasks 602 to a degree of relevance to a set of attributes 604, 606, 608, 610. Records 612 may then be accessed to determine if a particular agent is suitable to accept a task. For example, first agent 102 is provides biometric data indicating onset of influenza. It is generally known that muscle weakness is a symptom of influenza. Accessing task-demand data structure 600 to determine what tasks may be assigned to first agent 102 may then avoid tasks with a high degree of physical activity, as indicated by attribute 608.

FIG. 7 depicts agent-capacity data structure 700 in accordance with embodiments of the present disclosure. In one embodiment, agent-capacity data structure 700 includes records 712 indicating the performance of an agent, such as first agent 102 based upon observed performance of past tasks. The tasks 702 being associated with a set of attributes 704, 607, 708, 710.

For example, first agent 102 may have performed a highly physically demanding activity over the weekend and, based upon attribute 704, has in past been a high performer of “deliveries” task when having had a medium level of physical activity, been a low performer of “warehouse” task when having had a high level of physical activity, and been a medium performer of “deliveries” task during low levels of physical activity, but such low levels where accompanied by high levels of sleep deprivation and stress, as indicated by attributes 706 and 708. Accordingly, scheduling agent 102 for the “warehouse” task would be discouraged if their biometric data was associated with a prior strenuous activity. In another example, first agent 102 is determined to be under a lot of stress, associated with attribute 708. However, for tasks such as “deliveries” or “warehouse,” first agent 102 appears to be largely unaffected by stress.

In one embodiment, the determination of whether biometric data indicates an impairment may be determined on a case-by-case basis. For example, the demands of a particular task may be determined by accessing task-demand data structure 600. The impact of an impairment indicated by biometric data, for a particular agent, may be determined by accessing agent-capacity data structure 700. As a benefit, agents who are impaired, but personally unaffected to a significant degree, may be scheduled as usual. In contrast, agents who are particularly sensitive to an impairment may be assigned to tasks according to their impairment, even if such a degree of impairment would be of no consequence to agent having less sensitivity.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor (GPU or CPU) or logic circuits programmed with the instructions to perform the methods (FPGA). These machine-executable instructions may be stored on one or more machine-readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

Specific details were given in the description to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments were described as a process, which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine-readable medium such as a storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

While illustrative embodiments of the disclosure have been described in detail herein, it is to be understood that the inventive concepts may be otherwise variously embodied and employed, and that the appended claims are intended to be construed to include such variations, except as limited by the prior art.

1. A system comprising:
a network interface configured to receive, at a first time, a baseline biometric data of a first agent and, at a second time later than the first time, a screening biometric data of the first agent;
a processor determining whether a difference between the baseline biometric data of the first agent and the screening biometric data of the first agent indicates an impairment of the first agent; and
upon the processor determining the impairment of the first agent, a scheduling module configured to assign the first agent to a selected one of a first task and a second task in accord with the difference between the baseline biometric data of the first agent and the screening biometric data of the first agent indicating the first agent is better suited to the selected one of the first task and the second task.

2. The system of claim 1, further comprising:
the network interface being further configured to receive, at a third time, a baseline biometric data of a second agent and, at a fourth time later than the third time, a screening biometric data of the second agent;
the processor determining a difference between the baseline biometric data of the second agent and the screening biometric data of the second agent indicates a lack of impairment of the second agent; and
wherein the scheduling module is further configured to assign the first agent to the selected one of the first task and the second task upon determining the screening biometric data of the second agent is better suited to the non-selected one of the first task and the second task.

3. The system of claim 1, wherein the scheduling module is further configured to assign a second agent to the non-selected one of the first task and the second task.

4. The system of claim 1, further comprising:
a compensation module configured to determine whether the network interface has received valid biometric data from the first agent and modify a compensation of the first agent in accord with the first agent providing valid biometric data.

5. The system of claim 1, further comprising:
a compensation module configured to modify a compensation of the first agent upon determining the screening biometric data of the first agent qualifies the first agent to be assigned to the selected one of the first task and the second task, without regard to the first agent performing the selected one of the first task and the second task.

6. The system of claim 1, wherein the scheduling module assigns the first agent to the selected one of the first task and the second task at a fifth time, the fifth time being determined in accord with the screening biometric data sufficiently accurately predicting suitability of the first agent to perform the selected one of the first task and the second task at a second time in which the selected first task and second task is to be performed.

7. The system of claim 1, further comprising:
a database comprising a record further comprising a historic biometric data of the first agent and an associated measured performance of the first agent performing a prior first task, being substantially similar to the first task, and a prior second task, being substantially similar to the second task; and
the scheduling module determines the first agent is better suited for the selected one of the first task and the second task in accord with the historic biometric data indicating a greater suitability of the first agent to one of the first prior task and the second prior task.

8. The system of claim 1, further comprising:
the scheduling module being further configured to assign the first agent to the selected one of the first task and the second task in accord with the screening biometric data of the first agent indicating the performance of a prerequisite activity, by the first agent, for the selected one of the first task and the second task.

9. The system of claim 1, wherein:
the first task comprises a real-time interaction with a customer and the second task comprises a non-real-time interaction with the customer;
the scheduling module is further configured to assign the first task to the first agent upon determining the screening biometric data of the first agent indicates suitability to conduct real-time interactions; and
the scheduling module is further configured to assign the second task to the first agent upon determining the screening biometric data of the first agent indicates non-suitability to conduct real-time interactions.

10. A method comprising:
accessing, by a processor, a baseline biometric data of a first agent at a first time and, at a second time later than the first time, a screening biometric data of the first agent;
determining, by the processor, whether a difference between the baseline biometric data of the first agent and the screening biometric data of the first agent indicates an impairment of the first agent; and
upon the processor determining the impairment of the first agent, scheduling the first agent to a selected one of a first task and a second task in accord with the difference between the baseline biometric data of the first agent and the screening biometric data of the first agent indicating the first agent is better suited to the selected one of the first task and the second task.

11. The method of claim 10, further comprising:
accessing, by the processor, baseline biometric data of a second agent at a third time and, at a fourth time, later than the third time, a screening biometric data of the second agent;
determining, by the processor, a difference between the baseline biometric data of the second agent and the screening biometric data of the second agent indicates a lack of impairment of the second agent and
the step of scheduling further comprises scheduling the first agent to the selected one of the first task and the second task in accord with the screening biometric data of the second agent being better suited to the non-selected one of the first task and the second task.

12. The method of claim 10, further comprising scheduling a second agent to the non-selected one of the first task and the second task.

13. The method of claim 10, further comprising:
modifying a compensation of the first agent in accord with the first agent facilitating the accessing of the screening biometric data of the first agent, upon determining that the screening biometric data is valid.

14. The method of claim 10, further comprising:
modifying a compensation of the first agent upon determining the screening biometric data of the first agent qualifies the first agent to be assigned to the selected one of the first task and the second task, without regard to the first agent performing the selected one of the first task and the second task.

15. The method of claim 10, further comprising scheduling the first agent to the selected one of the first task and the second task at a fifth time, the fifth time being determined in accord with the screening biometric data being sufficiently predictive of the suitability of the first agent to perform the selected one of the first task and the second task at a second time in which the selected first task and the second task is to be performed.

16. The method of claim 10, further comprising:
accessing a historic biometric data of the first agent and an associated measured performance of the first agent performing at least one of a prior first task, being substantially similar to the first task, and a prior second task, being substantially similar to the second task; and
determining the first agent is better suited for the selected one of the first task and the second task in accord with the historic biometric data indicating a greater suitability of the first agent to one of the first prior task and the second prior task.

17. The method of claim 10, further comprising:
assigning the first agent to the selected one of the first task and the second task in accord with the screening biometric data indicating the performance of a prerequisite activity, by the first agent, for the selected one of the first task and the second task.

18. The method of claim 10, further comprises:
assigning in a first order of execution, the selected one of the first task and the second task in accord with the screening biometric data and, in a second order of execution, the non-selected one of the first task and the second task.

19. A system, comprising:
means to access, by a processor and at a first time, a baseline biometric data of a first agent and, at a second time later than the first time, a screening biometric data of the first agent;
means to determine, by the processor, whether a difference between the baseline biometric data of the first agent and the screening biometric data of the first agent indicates an impairment of the first agent; and
means to schedule, by the processor, upon determining the impairment of the first agent, the first agent to a selected one of a first task and a second task in accord with the difference between the baseline biometric data of the first agent and the screening biometric data of the first agent indicating the first agent is better suited to the selected one of the first task and the second task.

20. The system of claim 19, further comprising:
means to receive, by the processor and at a third time, a baseline biometric data of a second agent and, at a fourth time later than the third time, a screening biometric data of the second agent;
means to determine, by the processor, a difference between the baseline biometric data of the second agent and the screening biometric data of the second agent indicates a lack of impairment of the second agent; and
means to schedule the first agent to the selected one of the first task and the second task in accord with the screening biometric data of the second agent being better suited to the non-selected one of the first task and the second task.
